(19) United States
(12) Patent Application Publication
(10) Pub. No.: US 2021/0300238 A1
(43) Pub. Date: Sep. 30, 2021

(54) METHOD AND DEVICE FOR SIGNALING A DRIVERLESS OPERATING STATE OF A MOTOR VEHICLE

(71) Applicant: Robert Bosch GmbH, Stuttgart (DE)

(72) Inventors: Nico Latsch, Oppenweiler (DE); Sascha Heszler, Schwieberdingen (DE)

(21) Appl. No.: 16/322,205

(22) PCT Filed: Jun. 21, 2017
(86) PCT No.: PCT/EP2017/065214

§ 371 Date: Jan. 31, 2019

(30) Foreign Application Priority Data
Aug. 18, 2016 (DE) 10 2016 215 484.2

(51) Int. Cl. B60Q 1/50; B60Q 1/00

(52) U.S. Cl. CPC B60Q 1/50; B60Q 2400/20; B60Q 1/0035

(57) ABSTRACT

A method for signaling a driverless operating state of a motor vehicle in which the motor vehicle is able to drive without a driver, and as long as the motor vehicle is operated in the driverless operating state, a ground of an environment of the motor vehicle is illuminated by an illumination light with the aid of an undercarriage illumination device of the motor vehicle in order to be able to signal to the environment that the motor vehicle is operated in the driverless state. A corresponding device and a corresponding motor vehicle are also described.

### FIELD

The present invention relates to a method and a device for signaling a driverless operating state of a motor vehicle. In addition, the present invention relates to a motor vehicle.

### BACKGROUND INFORMATION

German Patent Application No. DE 10 2011 112 577 A1 describes a method for an assistance system, which is used to carry out an autonomous or partially autonomous driving maneuver of a vehicle, in particular a parking or unparking maneuver, and in which image data from a vehicle environment are obtained with the aid of a camera system and processed in order to carry out the driving maneuver, and at least one direction in which the vehicle is moving during the driving maneuver is indicated using at least one light-signal device.

The light-signal device, for example, is a light strip which is situated on the vehicle. For instance, the light strip is situated on one side or on both sides of the vehicle such as in the region of the vehicle doors or as an illumination of the undercarriage at the vehicle bottom, in particular in the region between the front and the rear axle of the vehicle.

Eye contact between a driver and other road users is usually lacking when a vehicle is driving without a driver. The driverless operation is consequently not detectable from the outside. This may pose a risk for other road users, in particular for pedestrians and bicyclists.

As a result, there is a need to signal to road users in the environment of a motor vehicle driving in a driverless manner that the vehicle is driving without a driver so that the road users may prepare themselves for such a situation and are able to respond to the situation appropriately.

### SUMMARY

An object of the present invention is to provide for the efficient signaling of a driverless operating state.

This objective may be achieved in accordance with the present invention. Advantageous embodiments of the present invention are described herein.

According to one aspect of the present invention, a method is provided for signaling a driverless operating state of a motor vehicle in which the motor vehicle is able to drive without a driver, and as long as the motor vehicle is operated in the driverless operating state, a ground of an environment of the motor vehicle is illuminated by an illumination light with the aid of an undercarriage illumination device of the vehicle in order to be able to signal to the environment that the motor vehicle is operated in the driverless operating state.

According to another aspect, a device is provided for signaling a driverless operating state of a motor vehicle in which the motor vehicle is able to drive without a driver, the device including:
An undercarriage illumination device for illuminating a ground of an environment of the motor vehicle using an illumination light, and
a control device for controlling the undercarriage illumination device such that as long as the motor vehicle is operated in the driverless operating state, the ground is illuminated by the illumination light in order to be able to signal to the environment that the motor vehicle is operated in the driverless operating state.

According to one further aspect, a motor vehicle is provided, which is developed to be operated in a driverless operating state in which the motor vehicle is able to be driven without a driver, and which includes the device for signaling a driverless operating state of a motor vehicle.

The present invention is based on the understanding that the aforementioned objective is able to be achieved by using an undercarriage illumination device of the motor vehicle in order to optically signal to the environment that the motor vehicle is operated in the driverless operating state. As long as the motor vehicle is operated in the driverless operating state, the ground of the environment of the motor vehicle is illuminated by the illumination light.

As a result, it is optically directly indicated to a road user in the surroundings or in the environment of the motor vehicle that the motor vehicle is operated in a driverless operating state. In an advantageous manner, the road user may thus adapt his or her behavior to the situation. For example, the road user is aware that no eye contact with a driver is possible so that ambiguous situations that relate to the right of way, for instance, are unable to be resolved via eye contact or hand signals, for instance. The road user may therefore act in a more cautious manner, which in turn is advantageously able to reduce a collision risk.

In particular, the technical advantage is obtained that the driverless operating state of the motor vehicle is able to be signaled in an efficient manner.

A driverless operating state within the meaning of the present invention in particular characterizes an operating state in which the motor vehicle is able to drive without a driver. Driverless driving in particular includes partially autonomous and/or autonomous and/or remotely controlled driving.

An illumination light within the meaning of the present invention describes electromagnetic radiation whose wavelength lies in the range of 380 nm to 780 nm. An illumination light within the meaning of the present invention thus involves a component of the electromagnetic radiation which the human eye is able to perceive.

According to one specific embodiment, it is provided that when a road user is detected in the environment of the motor vehicle, a current color of the illumination light is changed to a different color, in particular to red, so that it may be signaled to the road user that the road user was detected.

This particularly achieves the technical advantage that it is possible to efficiently signal to the road user that he or she was detected because a road user normally recognizes a change in the illumination light very well. Especially when the current color is changed to red, particularly efficient signaling is induced to the effect that it is indicated that the road user was detected. This is because red is usually a warning color so that the road user will respond to such a color with particular attention.

Red illumination light within the meaning of the present invention in particular describes light that has a spectral distribution with a global maximum in a range between 600 nm and 780 nm.

A current color of the illumination light is blue, for instance.

Blue illumination light within the meaning of the present invention in particular describes light that has a spectral distribution with a global maximum in a range between 460 nm and 480 nm.

According to one further embodiment, it is provided that in a predefined time interval before the motor vehicle starts driving from standstill, the ground is illuminated using illumination light of a first color, in particular using a green illumination light, whereas once the vehicle has started driving, the ground is illuminated using an illumination light of a second color that differs from the first color, in particular using a blue illumination light.

This achieves the particular technical effect that it is possible to efficiently signal to road users in the environment of the motor vehicle that the motor vehicle will begin to drive. As a result, for example, it may be avoided that the road user will be surprised by the starting movement of the vehicle.

The predefined time interval amounts to maximally 5 seconds, for example, in particular to maximally 3 seconds, and especially to maximally one second.

Green illumination light within the meaning of the present invention in particular describes light that has a spectral distribution with a global maximum that lies in a range between 520 nm and 565 nm.

According to one further specific embodiment, it is provided that during a stop of the motor vehicle, the ground will be illuminated using an illumination light of a different color than during a locomotion of the motor vehicle.

This particularly achieves the technical advantage that a road user in the surroundings or in the environment of the motor vehicle is able to efficiently recognize whether the motor vehicle is currently stopped or is currently moving. As a result, an efficient distinction can be made between a stopped and a moving motor vehicle.

According to one specific embodiment, it is provided that the device for signaling a driverless operating state of a motor vehicle is developed or set up to implement or carry out the method for signaling a driverless operating state of a motor vehicle.

According to a still further specific embodiment, it is provided that the method for signaling a driverless operating state of a motor vehicle is implemented or carried out with the aid of the device for signaling a driverless operating state of a motor vehicle.

Technical functionalities of the device similarly result from corresponding technical functionalities of the method, and vice versa. Therefore, this particularly means that device features result from corresponding method features, and vice versa.

According to one specific embodiment, it is provided that the undercarriage illumination device is situated on the bottom of the motor vehicle.

According to one specific embodiment, it is provided that the undercarriage illumination device includes one or a plurality of illumination means.

According to one specific embodiment, it is provided that at least one or a plurality of illumination means is disposed on the bottom of the motor vehicle. The bottom of the motor vehicle is denoted as a vehicle bottom, in particular.

According to one specific embodiment, it is provided that at least one or a plurality of illumination means is disposed in the region between the front and the rear axle of the motor vehicle, especially directly abutting an outer edge of the bottom of the motor vehicle.

An illumination means within the meaning of the present invention is a light-emitting diode, for example.

In one specific embodiment, a plurality of light-emitting diodes is provided, the plurality of light-emitting diodes including one or more light-emitting diode(s) emitting red light, and/or one or more light-emitting diode(s) emitting green light, and/or one or more light-emitting diode(s) emitting blue light.

This achieves the particular technical advantage that efficient color mixing of the respectively emitted light is able to be realized with the aid of light-emitting diodes that emit different light. Through a color mixture of red, green and blue light, it is possible, for instance, to efficiently adjust a specific color of the illumination light in the RGB color space.

In one specific embodiment, it is provided that the control device is developed to control the undercarriage illumination device in such a way that when a road user is detected in the environment of the motor vehicle, a current color of the illumination light will be changed to another color, in particular to red, so that it may be signaled to the road user that the road user was detected.

According to one further specific embodiment, it is provided that the control device is developed to control the undercarriage illumination device in such a way that during a predefined time period prior to an initial acceleration of the motor vehicle from a standstill, the ground is illuminated by illumination light of a first color, in particular by a green illumination light, and after the initial acceleration, the ground is illuminated by illumination light of a second color which differs from the first color, in particular by blue illumination light.

According to one further specific embodiment, it is provided that the control device is developed to control the undercarriage illumination device in such a way that when the motor vehicle is stopped, the ground is illuminated by an illumination light of a different color than when the motor vehicle is in motion.

According to one specific embodiment, it is provided that the motor vehicle stops when a road user is detected in the environment of the motor vehicle.

According to one further specific embodiment, it is provided that the motor vehicle is located inside a parking lot when it is operated in the driverless operating state. For example, it is provided that the motor vehicle is driving without a driver inside the parking lot. Thus, a mixed operation of motor vehicles that are driving without a driver and motor vehicles that are driven by a driver is able to be carried out in an efficient manner.

A road user within the meaning of the present invention is a pedestrian, for instance. A road user within the meaning of the present invention, for example, is a further motor vehicle. A road user within the meaning of the present invention is a bicyclist, for instance.

The detection of a road user is based on an environment detection with the aid of an environmental sensor of the motor vehicle, for example. For instance, the detection of the road user is based on an environment detection with the aid of an environment sensor which is situated outside of or at a distance from the motor vehicle. Such an environmental sensor is situated inside a parking lot, for example.

According to one specific embodiment, a plurality of environmental sensors is used for the detection.

For instance, an environmental sensor within the meaning of the present invention is one of the following environmental sensors: a radar sensor, lidar sensor, an infrared sensor, a magnetic sensor, an ultrasonic sensor, a laser sensor and a video sensor.

According to one specific embodiment, the motor vehicle has on its vehicle bottom a plurality of light-emitting diodes, which are generally referred to as illumination means. The light-emitting diodes, generally referred to as illumination means, are preferably disposed on the vehicle bottom such that they are able to emit light in the direction of a driving surface or a ground.

The light-emitting diodes, generally referred to as illumination means, according to one specific embodiment are situated on the vehicle bottom, abutting a left and right outer edge of the vehicle bottom, ‘left’ and ‘right’ relating to the main driving direction of the motor vehicle.

In one specific embodiment, instead of or in addition to the left and right lateral placement abutting the outer edge, the light-emitting diodes are disposed on the vehicle bottom at a front and/or rear outer edge of the vehicle bottom, ‘front’ and ‘rear’ relating to the main driving direction of the motor vehicle.

The plurality of light-emitting diodes, generally referred to as illumination means, thus forms an undercarriage illumination device.

‘Abutting the outer edge’ in particular is generally understood as a maximum distance of the illumination means from the outer edge of 20 cm, in particular 10 cm.

According to one specific embodiment, it is provided that the illumination means are disposed on the vehicle bottom at a distance of maximally 20 cm, for example, in particular 10 cm, from the (left and/or right and/or front and/or back) outer edge of the vehicle bottom.

The directional indications ‘left’, ‘right’, ‘front’ and ‘back’ relate to the main driving direction of the motor vehicle.

Below, the present invention will be described in greater detail with the aid of preferred exemplary embodiments.

### BRIEF DESCRIPTION OF THE DRAWINGS

FIG. 1 shows a flow diagram of a method for signaling a driverless operating state of a motor vehicle.

FIG. 2 shows a device for signaling a driverless operating state of a motor vehicle

FIG. 3 shows a motor vehicle.

### DETAILED DESCRIPTION OF EXAMPLE EMBODIMENTS

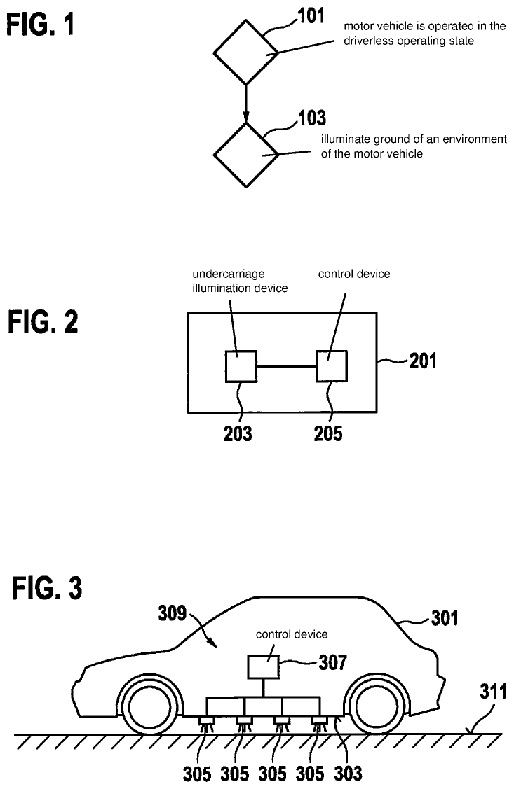

FIG. 1 shows a flow diagram of an example method in accordance with the present invention for signaling a driverless operating state of a motor vehicle in which the motor vehicle is able to drive without a driver. According to a step 101, it is provided that the motor vehicle is operated in the driverless operating state. As long as the motor vehicle is operated in the driverless operating state, it is provided according to a step 103 that a ground of an environment of the motor vehicle is illuminated by an illumination light with the aid of an undercarriage illumination device of the motor vehicle in order to make it possible to signal to the environment that the motor vehicle is operated in the driverless operating state.

A ground within the meaning of the present invention is a driving surface, for example.

FIG. 2 shows a device 201 for signaling a driverless operating state of a motor vehicle in which the motor vehicle is able to drive without a driver.

Device 201 encompasses:
An undercarriage illumination device 203 for illuminating a ground of an environment of the motor vehicle by an illumination light; and
a control device 205 for controlling the undercarriage illumination device in such a way that as long as the motor vehicle is operated in the driverless operating state, the ground is illuminated by the illumination light in order to signal to the environment that the motor vehicle is operated in the driverless operating state.

FIG. 3 shows a motor vehicle 301, which is driving on a driving surface 311.

Motor vehicle 301 is developed to be operated in a driverless operating state.

Motor vehicle 301 has on its vehicle bottom 303 a plurality of light-emitting diodes 305. Light-emitting diodes 305 are disposed on vehicle bottom 303 in such a way that they are able to emit light in the direction of driving surface 311.

According to one specific embodiment, light-emitting diodes 305 are situated adjacent to a left and right outer edge of vehicle bottom 303, ‘left’ and ‘right’ relating to the main driving direction of the motor vehicle.

In one specific embodiment, instead of or in addition to the left and right lateral placement abutting the outer edge, light-emitting diodes 305 are situated on a front and/or rear outer edge of vehicle bottom 303, ‘front’ and ‘rear’ relating to the main driving direction of the motor vehicle.

The plurality of light-emitting diodes 305 thus forms an undercarriage illumination device.

In addition, motor vehicle 301 includes a control device 307, which is developed to control the undercarriage illumination device formed by light-emitting diodes 305 in such a way that driving surface 311 is illuminated by the illumination light of light-emitting diodes 305 as long as motor vehicle 301 is operated in the driverless operating state, so that it is possible to signal to the environment that the motor vehicle is operated in the driverless operating state.

As a result, motor vehicle 301 includes a device 309 for signaling a driverless operating state of a motor vehicle according to one specific embodiment of the present invention.

For example, it is provided that driving surface 311 is illuminated by blue illumination light as long as the motor vehicle drives without a driver at a velocity of >0 m/s.

For instance, it is provided that when a road user is detected in the environment of motor vehicle 301, the blue illumination light is changed to red illumination light so that driving surface 311 will then be illuminated by red illumination light.

According to one specific embodiment, it is provided that motor vehicle 301 stops when the road user is detected.

According to one specific embodiment, it is provided that if motor vehicle 301 is standing still, i.e. has stopped but intends to accelerate immediately, i.e. wants to begin driving, driving surface 311 will be illuminated by green illumination light.

This then particularly means that different driving states of the motor vehicle are efficiently able to be signaled to an environment with the aid of different color codes. As a result, the present invention particularly provides an efficient, color-based communication between a motor vehicle driving in a driverless manner and its environment, i.e. its surroundings.

An undercarriage illumination device within the meaning of the present invention is therefore particularly developed to emit illumination light of different colors. For instance, it is provided that the undercarriage illumination device includes a plurality of light-emitting diodes, which emit different light in each case. For example, the undercarriage illumination device includes a plurality of light-emitting diodes which emit red illumination light. The undercarriage illumination device has a plurality of light diodes that emit green illumination light, for instance. The undercarriage illumination device, for example, includes a plurality of light-emitting diodes which emit blue illumination light.

Depending on the specific situation or the respective current driving state, according to one specific embodiment, it is thus provided that different light-emitting diodes are actuated so that different illumination light is correspondingly emitted.

The wording ‘respectively’ in particular encompasses the wording ‘and/or’.

In summary, the present invention thus provides an efficient concept which efficiently makes it possible to draw the attention of outsiders, i.e., road users in an environment of a motor vehicle, to an instantaneous or current driving state of the motor vehicle which is operated in the driverless operating state, this being accomplished by using differently colored illumination light of an undercarriage illumination device.

According to one specific embodiment, the following color codes are provided, individually or on combination:

Blue illumination light signals that the motor vehicle is driving without a driver at a velocity of >Om/s.

Red illumination light signals that the motor vehicle has detected an obstacle such as a pedestrian, whereupon the vehicle stops, in particular.

Green illumination light in particular signals that the motor vehicle is standing still but will begin to move within a predefined period of time such as in maximally three seconds, and in particular in maximally two seconds.

1-9 (canceled)

10. A method for signaling a driverless operating state of a motor vehicle, the driverless operating state being a state in which the motor vehicle is able to drive without a driver, the method comprising:
illuminating a ground of an environment of the motor vehicle using an illumination light with the aid of an undercarriage illumination device of the motor vehicle to signal to the environment that the motor vehicle is operated in the driverless operating state.

11. The method as recited in claim 10, wherein when a road user is detected in the environment of the motor vehicle, a current color of the illumination light is changed to a different color, in particular to red, in order to be able to signal to the road user that the road user was detected.

12. The method as recited in claim 10, wherein within a predefined period of time before the motor vehicle begins to move from standstill, the ground is illuminated by green illumination light, and after the start of driving, the ground is illuminated by an illumination light by blue illumination light.

13. The method as recited in claim 10, wherein when the motor vehicle is stopped, the ground is illuminated by illumination light of a different color than during a locomotion of the motor vehicle.

14. A device for signaling a driverless operating state of a motor vehicle in which the motor vehicle is able to drive without a driver, the device comprising:
an undercarriage illumination device configured to illuminate a ground of an environment of the motor vehicle by an illumination light; and
a control device configured to control the undercarriage illumination device such that the ground is illuminated by the illumination light as long as the motor vehicle is operated in the driverless operating state, in order to signal to the environment that the motor vehicle is operating in the driverless operating state.

15. The device as recited in claim 14, wherein the control device is configured to control the undercarriage illumination device in such a way that when a road user is detected in the environment of the motor vehicle a current color of the illumination light is changed to red to signal to the road user that the road user was detected.

16. The device as recited in claim 14, wherein the control device is configured to control the undercarriage illumination device in such a way that during a predefined period of time before the motor vehicle begins to move from standstill, the ground is illuminated by green illumination light, and after the start of driving, the ground is illuminated by blue illumination light.

17. The device as recited in claim 14, wherein the control device is configured to control the undercarriage illumination device in such a way that during a stop of the motor vehicle, the ground is illuminated by an illumination light of a different color than during a locomotion of the motor vehicle.

18. A motor vehicle, which is configured to be operated in a driverless operating state in which the motor vehicle is able to drive without a driver, comprising:
a device for signaling a driverless operating state of a motor vehicle in which the motor vehicle is able to drive without a driver, the device including an undercarriage illumination device configured to illuminate a ground of an environment of the motor vehicle by an illumination light, and a control device configured to control the undercarriage illumination device such that the ground is illuminated by the illumination light as long as the motor vehicle is operated in the driverless operating state, in order to signal to the environment that the motor vehicle is operating in the driverless operating state.
